(19) United States
(12) Patent Application Publication
(10) Pub. No.: US 2014/0279368 A1
(43) Pub. Date: Sep. 18, 2014

(54) METHOD AND APPARATUS FOR GCF REPO INDEX INSTRUMENT

(71) Applicant: Gary Chan, New York, NY (US)

(72) Inventor: Gary Chan, New York, NY (US)

(73) Assignee: The Depository Trust and Clearing Corporation (DTCC), New York, NY (US)

(21) Appl. No.: 14/215,591

(22) Filed: Mar. 17, 2014

Related U.S. Application Data
(60) Provisional application No. 61/788,539, filed on Mar. 15, 2013.

(51) Int. Cl. G06Q 40/04

(52) U.S. Cl. CPC G06Q 40/04
USPC 705/37

(57) ABSTRACT

A method and system for a GCF repo swap transaction includes generating an index using a limited set of GCF contracts, and using the index value as a value in a GCF repo swap. The index value may be used as a variable or floating value in the swap, or may be used at the fixed value in the swap.

### CROSS REFERENCE TO RELATED APPLICATION

The present application claims the benefit of U.S. Provisional Patent Application Ser. No. 61/788,539, filed Mar. 15, 2013, which is incorporated herein by reference.

### BACKGROUND OF THE INVENTION

1. Field of the Invention

The present invention relates generally to a method and apparatus for investing that includes a swap of repurchase agreements, or repos.

2. Description of the Related Art

US Published Pending Application US 2009/0099956 to Skyrm published on Apr. 16, 2009, discloses a system for facilitating a swap between the floating and fixed markets in the repurchase agreement (or repo) market. Skyrm discloses that fixed term rates in the repurchase market have existed for year. Skyrm proposes a swap between the fixed rate market and a floating market wherein a floating rate is the daily broker averages or a quarterly or monthly rate. Skrym describes a contract for differences, or CFD, in a repo swap wherein an agreement between two parties to pay the difference between the fixed and floating rates for a specified period of the trade. Skyrm states that the floating rate is the weighted average of one or more electronic or voice repo broker screens to obtain a daily rate. Skyrm describes the majority of repo transactions as overnight trades for just one day.

An overnight indexed swap (OIS) is an interest rate swap where the periodic floating rate of the swap is equal to the geometric average of an overnight index rate over every day of the payment period. The index rate is typically a central bank rate or equivalent, for example the Federal funds rate in the US. Overnight Index Swaps are instruments that allow financial institutions to swap the interest rates they are paying without having to change the terms of contracts in place with other financial institutions.

The fixed rate of OIS is typically an interest rate considered less risky than the corresponding interbank rate (LIBOR), because it is based on a central bank rate and only the net difference in interest rates is paid at maturity of the swap so there is limited counterparty risk.

The LIBOR-OIS spread is the difference between LIBOR and the (OIS) rates. The spread between the two rates is considered to be a measure of health of the banking system. It is an important measure of risk and liquidity in the money market, A higher spread (high Libor) is typically interpreted as indication of a decreased willingness to lend by major banks, while a lower spread indicates higher liquidity in the market. As such, the spread can be viewed as indication of banks' perception of the creditworthiness of other financial institutions and the general availability of funds for lending purposes.

LIBOR is risky in the sense that the lending bank loans cash to the borrowing bank, and the OIS is stable in the sense that both counterparties only swap the floating rate of interest for the fixed rate of interest. The spread between the two is, therefore, a measure of how likely borrowing banks will default. This reflects counterparty credit risk premiums in contrast to liquidity risk premiums. However, given the mismatch in the tenor of the funding, it also reflects worries about liquidity risk as well.

The TED spread is the difference between the interest rates on interbank loans and on short-term U.S. government debt (“T-bills”). TED is an acronym formed from T-Bill and ED, the ticker symbol for the Eurodollar futures contract.

Initially, the TED spread was the difference between the interest rates for three-month U.S. Treasuries contracts and the three-month Eurodollars contract as represented by the London Interbank Offered Rate (LIBOR). However, since the Chicago Mercantile Exchange dropped T-bill futures after the 1987 crash, the TED spread is now calculated as the difference between the three-month LIBOR and the three-month T-bill interest rate.

Repos are a form of term secured funding that involves the sale of a security and the subsequent repurchase, typically starting on the same day with a next-day settlement. Unlike standard repos, in which contracts are executed on a specific security, GCF Repos are traded by general collateral categories and are settled net as part of a tri-party process.

In FIG. 1, a GCF (general collateral finance) trade flow is shown wherein Dealer A, at block 10, sells $1 billion in GCF to Dealer B, at block 12, on an overnight basis through a Blind Broker, block 14. The Blind Broker 14 submits/alleges trade to FICC (Fixed Income Clearing Corporation), at block 16, and the dealers affirm the trade through the FICC website. FICC serves as the clearing house for trading in U.S. government securities. FICC personnel monitor the allege/affirm process for exceptions throughout the day. A 3:00 PM cutoff is set for all Broker GCF Repo trade submissions and member dealer affirmations.

DTCC began publishing the DTCC GCF Repo Index® in November 2010. It is the first index to track general collateral finance repurchase agreements (GCF Repos®) transactions. The index includes the weighted average of the interest rates paid each day on overnight transactions involving GCF Repos, based on three basic types of U.S. government securities: U.S. Treasury securities with less than 30-year maturity; non-mortgage-backed U.S. agency securities; and Fannie Mae and Freddie Mac fixed-rate MBS. To qualify for inclusion in the DTCC GCF Repo Index, the transactions in each of these must be completed on a daily basis.

### SUMMARY OF THE INVENTION

The present invention provides a method and system for enabling a swap trade in the repurchase agreement, or repo, market using a published index value as one of the fixed or floating rate values in the swap. In particular, a repo swap may be carried out using an index of cleared repo trades as either the floating rate in the swap trade or as the fixed rate in the swap trade.

The method and system facilitates a swap between the floating and fixed rate markets and the DTCC GCF Repo Index. Other index values may be provided instead. The present method and system also provides a market for trading such instruments based on the swap transactions.

In the swap transaction, a determination is made of the fixed rate for a repo market transaction, a determination is made of a variable rated for the repo market transaction, a determination is made of the difference between the fixed rate and the variable rate, and an exchange is made between the parties to the transaction based on the determined difference, wherein the fixed rate is based on the index and the variable rate is based on the daily average floating rate for the stated period. Alternately, the repo market transaction is carried out using a variable rate is based on the index. In one embodiment, the repo market transaction is based on the index value.

### BRIEF DESCRIPTION OF THE DRAWINGS

FIG. 1 is a block diagram of a GCF trade flow;

FIG. 2 is a functional block diagram showing the distribution of the repo index data for use in the present method;

FIG. 3 is a function block diagram showing another distribution of the repo index data;

FIG. 4 shows the channels by which the index data can be accessed;

FIG. 5 is a block diagram of a GCF repo swap that uses the GCF repo index as a value in the swap.

### DETAILED DESCRIPTION OF THE PREFERRED EMBODIMENTS

Swaps according to the present invention are performed using the GCF repo index as a value in the swap. The index value can be used as the floating value or as the fixed value in the repo swap.

Although other index values are possible within the scope of this invention, the preferred embodiment utilizes the DTCC GCF Repo Index®. The DTCC GCF Repo Index® differs from most existing benchmarks in that it is not based on subjective rate estimates. Instead, it reflects actual, fully collateralized and centrally cleared repo transactions. This key difference ensures the index cannot be manipulated, which provides the market with greater transparency and better risk mitigation.

The DTCC GCF Repo Index® is the only index that tracks the average daily interest rate paid for the most-traded GCF Repo contracts for U.S. Treasury bonds, federal agency paper and mortgage-backed securities [MBS] issued by Fannie Mae and Freddie Mac. These are instruments that clear at DTCC's Fixed Income Clearing Corporation [FICC].

The index's rates are par-weighted averages of daily activity in the GCF Repo market and reflect actual daily funding costs experienced by banks and investors, per underlying asset class.

The source transaction data is from the GCF Repo market. Unlike standard repos, in which contracts are executed on a specific security, GCF Repos are traded by general collateral categories and are settled net as part of the tri-party process.

Trading in GCF Repos averaged more than $400 billion a day in 2012. The GCF Repo service enables dealers that are members of the Government Securities Division of FICC to trade GCF Repos based on rate, term and the underlying product, throughout the day without requiring intraday, trade-for-trade settlement on a delivery-versus-payment basis.

The GCF Repo index represents a better floating rate indicator, because it represents what banks are willing to lend to other GCF banks in a “risk-free” secured and margined basis. As the market moves away from un-secured lending it is only appropriate migrate to a secured benchmark like the GCF Repo index.

As such the GCF Repo index is a viable replacement for Libor and a better indicator of the Risk of the roughly 60 GCF banks that trade this product on a daily average, with ˜300 billion in funding cleared through the FICC a subsidiary of DTCC.

During the transition period and thereafter, as firms convert to the GCF-OIS measure of risk, the transactions to invest in that market will need to change as well. The new transaction of choice will be the GCF-OIS swap, which will be used to “hedge” the interest rate exposure between the Fixed rate (OIS) and the Floating Rate (GCF Repo).

### Trading Examples

The following relates to a floating rate to fixed rate swap.

Firm A anticipates that rate will rise, and wants to convert to a fixed instrument, whereas Firm B anticipates that rates will fall and wants to convert to a variable instrument.

| Firm A | | Firm B |
|---|---|---|
| 100 mm 30 yr loan | 30 yr Swap | 100 mm 30 yr loan |
| @ Variable Rate | | @ 5% Fixed Rate |

A swap is created by Firm B effectively taking the variable rate 30 year instrument in return for Firm A effectively taking the fixed rate 30 year instrument. The difference is the spread between the variable rate and the fixed rate. When done overnight and based on an index thee swap is referred to as an OIS (overnight Index Swap).

| Firm A Liabilities | Firm B Liabilities |
|---|---|
| Initial Fixed rate swap vs OIS | Initial Variable rate vs OIS |

In order for firms A and B to hedge their future cash flows on this swap they may enter into additional interest rate swap hedges. According to an embodiment of the invention, the parties enter into a GCF-OIS swap which will better allow their future costs of borrowing the “variable” rate to their fixed cost “OIS”.

In FIG. 2, a GCF database 20 stores GCF index data that will be used in the present method and system. The GCF database 20 communicates with a FIDO (fixed income data on-line) component 22 of a web application server 24. Each day the FIDO 22 will wait for the most recent GCF index data to become available and pre-compute an XML based feed which will be made available via the web service interface 24. Once the most current GCF index becomes available and the data is validated, FIDO 22 sets a flag that publishers can check before initiating a transaction. The GCF index data is ready flag 26 is set in the FIDO configuration database 28.

A mainframe computer 30 includes a CA scheduler 32. The CA scheduler 32 works with a scheduling service to push GCF index data to publishers as soon as it becomes available. In the illustrated example, the scheduler operates at 3:00 pm each trading day. The publishers of the illustrated example are Bloomberg and the Wall Street Journal.

A windows server 34 waits for the GCF index data, at 36. Upon receiving the index data, the server generates and/or validates a feed structure, at 38. The server 34 transmits the feed, as indicated at 40. The outgoing feed of index data is indicated by FTP communication link 44 to the Bloomberg/Wall Street Journal block 46, which is accomplished via the internet 48. After the index data is transmitted, the server 34 generates reports at 42. The transmission of the index data is indicated as a single transmission 44, although it is accomplished via separate transmissions in the preferred embodiment.

Users seeking the index information may obtain it by an electronic inquiry, such as via a web site 50, shown here as DTCC.com. A secure connection 52 such as secure HTTP (HTTPS) or SOAP (simple object access protocol) provides a connection to the FIDO 22 to request the index data to be send to the web site, also over the internet 48.

Other network communications may be provided. The elements used in the communication are computers and/or computer devices such as servers, workstations, desktop computers, laptop computers, tablet computers, smart phones, PDAs, kiosks, and other types of computers or computer devices. Software operating on the computer devices carry out the steps of the method. The software including computer programs and data is stored on tangible computer readable media for use by the computer devices.

In FIG. 3 a FIDO 60 transmits to a FIDO configuration 62 an indication that the CF index data is ready, which sets a flag. The FIDO 60 is in a web server 64 that receives secure requests via the internet 66 from the web site 68. A mainframe computer 70 includes a scheduler 72 that transmits to a windows server 74. The windows server 74 checks to see if the GCF index data is ready, at 76, initiates an FTP connection to Bloomberg, at 78, and prepares a report, at 80. The FTP communication 82 is transmitted via the internet 66 to the publisher Bloomberg 84. A check is made at 86 that the flag is set.

Turning to FIG. 4, the FIDO 90 is provided in an application server 92. The FIDO 90 provides data to FIDO logs 94, which communicates via a network file system (NFS) 96 through a firewall 98 to a log server 100. The log server 100 may be accessed by an internal user 102 via a secure shell 104 through a firewall 106. A remote user 108 using a remote access program such as Citrix may access the log server 100 via a secure shell/secure FTP connection 110, which is also through a firewall 106.

An alternate embodiment is shown including the FIDO 90 in the application server 92 with FIDO logs 94 that are directly in communication with an in-house user 112 via a secure shell/secure FTP connection 114 via a firewall 116. The users thereby obtain access to the index data for setting up the repo swap, monitoring the status of the swap, and for settling the swap.

In FIG. 5, party A 120 wishes to transact a repo swap with party B 122. The parties 120 and 122 act through a broker 124 to transact the swap, which is typically an over-the-counter (OTC) transaction. The swap uses the repo index value 126 as a value in the swap.

Thus, the repo swap is based on an index that is determined by cleared trades. The index value on which the swap is based has clearly defined parameters for arriving at the value, is widely published each day, and is a reliable value on which to base the swap transaction.

The GCF Repo® service enables dealers to trade general collateral repos, based on rate, term, and underlying product, throughout the day without requiring intra-day, trade for trade settlement on a Delivery versus Payment (DVP) basis. The service helps foster a highly liquid market for securities financing. Dealers execute GCF Repos through inter-dealer brokers on an anonymous or “blind” basis. FICC guarantees settlement as soon as it receives the data from the brokers and compares the transaction. GCF Repo transactions are settled on a tri-party basis, which requires dealers to have an account with either one or both of the participating clearing banks; the Bank of New York Mellon or JP Morgan Chase.

An investor seeking to invest in the repo swap market has a well-defined value on which to base the swap. Depending on the agreement of the parties to the swap, the repo index value may be used as a fixed value in the swap or as a floating value. The swap may be an overnight swap, may extend for one or more days, may extend for one or more weeks or may extend for one or more months. It is even possible that the swap may extend for years.

The published index value permits the parties to the repo swap to readily determine the outcome of the swap.

Although other modifications and changes may be suggested by those skilled in the art, it is the intention of the inventors to embody within the patent warranted hereon all changes and modifications as reasonably and properly come within the scope of their contribution to the art.

We claim:

1. A method for conducting a repo SWAP financial transaction, the method comprising the steps of:
in a computer, determining a fixed rate for a repo market transaction;
in a computer, determining a variable rate for a repo market transaction;
in a computer, determining a difference between the fixed rate and the variable rate; and
in a computer, exchanging an amount based on the determined difference, between parties to the transaction,
wherein one of the fixed rate and the variable rate is based on a repo index value.

2. A method as claimed in claim 1, wherein the repo index value is the DTCC Repo Index value.

3. A method for generating a repo index value for use in a repo swap, comprising the steps of:
in a computer, preparing a weighted average of interest rates paid on overnight GCF repo transactions for GCF contracts on a predetermined set of tradable instruments as index data;
flagging the index data as ready;
receiving the index data in a server;
generating a feed structure of the index data in the server;
transmitting the index data in the feed structure to a publisher via a secure communication link;
using the published index data as a value in a repo swap transaction.
